(19) United States
(12) Patent Application Publication
(10) Pub. No.: US 2008/0270607 A1
(43) Pub. Date: Oct. 30, 2008

(54) METHOD FOR MANAGING WIRELESS NETWORK AND WIRELESS DEVICE EMPLOYING THE SAME

(75) Inventors: Joon-hyuk RYU, Suwon-si (KR); Seung-seop Shim, Anyang-si (KR); Moon-seok Han, Suwon-si (KR); Seung-hyuk Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/873,553

(22) Filed: Oct. 17, 2007

Related U.S. Application Data
(60) Provisional application No. 60/913,642, filed on Apr. 24, 2007.

(30) Foreign Application Priority Data
Jun. 15, 2007 (KR) 10-2007-0059060

(51) Int. Cl. G06F 15/16

(52) U.S. Cl. 709/225

(57) ABSTRACT

A method for managing a wireless network and a wireless device employing the same are provided. The method for managing a wireless network disassociates a wireless device determined to be disassociatable from the wireless network. Accordingly, since an existing wireless device is forcedly disassociated, the configuration of the wireless network can be artificially changed.

### CROSS-REFERENCE TO RELATED APPLICATIONS

This application claims priority from U.S. Provisional Application No. 60/913,642, filed Apr. 24, 2007, in the United States Patent and Trademark Office and claims priority from Korean Patent Application No. 10-2007-0059060, filed Jun. 15, 2007, in the Korean Intellectual Property Office, the disclosure of which is incorporated herein by reference in its entirety.

### BACKGROUND OF THE INVENTION

1. Field of the Invention

Methods and apparatuses consistent with the present invention relate to managing a wireless network, and more particularly, to managing association and disassociation of wireless devices configuring a wireless network.

2. Description of the Related Art

The advent of a wireless personal area network (WPAN) enables home networking to be realized within the home, and thus it is expected that the user's convenience and entertainment will increase.

In general, the WPAN is automatically formed by neighboring WPAN-devices rather than artificially formed by a user. The WPAN has small coverage such that the number of WPAN-devices the WPAN can accept is limited.

If the number of WPAN-devices reaches a certain number limit, the WPAN will not accept another WPAN-device. Accordingly, the WPAN-device which is not accepted by the WPAN should join another WPAN or establish a new WPAN for itself. However, if neither is possible, the WPAN-device is isolated.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for managing a network by determining a wireless device to be disassociated from a wireless network and disassociating the determined wireless device, and a wireless device employing the same.

According to an aspect of the present invention, there is provided a method for managing a wireless network, the method comprising: among wireless devices configuring a wireless network, determining a wireless device to disassociate from the wireless network; and transmitting a disassociation request message to the wireless device which is to be disassociated from the wireless network.

The method may further comprise receiving information about the wireless devices configuring the wireless network, and the determining step may comprise determining a wireless device to be disassociated from the wireless network based on the information about the wireless devices received at the receiving step.

The information about the wireless devices may be information indicating whether or not each of the wireless devices can join another wireless network different from the wireless network, and the determining step may comprise determining at least one of the wireless devices that can join another wireless network as a wireless device to be disassociate from the wireless network.

The information about the wireless devices may comprise information about a type of data treated by each of the wireless devices, information about an amount of data transceived by each of the wireless devices, information about a transmission power of each of the wireless devices, and information about a priority order of each of the wireless devices.

The determining step may be performed if the sum of the number of wireless devices currently configuring the wireless network and the number of wireless devices which wish to join the wireless network exceeds the number of wireless devices that the wireless network can accept.

If a wireless device which wishes to join the wireless network appears, the sum may exceed the number of wireless devices that the wireless network can accept.

The determining step may be performed in either case where a channel used by the wireless network is in a bad condition or where a load of a wireless device adapted to manage the wireless network increases.

The determining and the transmitting steps may be performed by a wireless device adapted to manage the wireless network.

The wireless network may be either a wireless personal area network (WPAN) or a wireless local area network (WLAN).

The method may further comprise: transmitting an association approval message to a wireless device which requests approval for association with the wireless network; and transmitting information about the wireless network which has been transformed as a result of disassociating the wireless device which is to be disassociated from the wireless network and associating the wireless device which requests approval for association with the wireless network, to the wireless devices configuring the wireless network.

According to another aspect of the present invention, there is provided a wireless device comprising: a communication interface which is communicably coupled to wireless devices configuring a wireless network; and a processor which determines a wireless device to be disassociated from the wireless network, and transmits a disassociation request message to the wireless device which is to be disassociated from the wireless network through the communication interface.

The processor may receive information about the wireless devices configuring the wireless network through the communication interface, and determine a wireless device to be disassociated from the wireless network based on the information about the wireless devices.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating a wireless network to which an exemplary embodiment of the present invention is applicable;

FIG. 2 is a view illustrating a method for managing a piconet of a piconet coordinator (PNC) according to an exemplary embodiment of the present invention;

FIG. 3 is a view illustrating a piconet which has been transformed as a result of disassociating and associating wireless devices from and with the piconet.

FIG. 4 is a block diagram illustrating a wireless device according to another exemplary embodiment of the present invention; and

FIG. 5 is a flowchart illustrating a method for managing a wireless network according to another exemplary embodiment of the present invention.

### DETAILED DESCRIPTION OF EXEMPLARY EMBODIMENTS OF THE PRESENT INVENTION

Certain exemplary embodiments of the present invention will be described in greater detail with reference to the accompanying drawings.

In the following description, the same drawing reference numerals are used for the same elements even in different drawings. The matter defined in the description, such as detailed construction and elements, are provided to assist in a comprehensive understanding of the invention. Thus, it is apparent that the exemplary embodiments of the present invention can be carried out without this specifically defined matter. Also, well-known functions or constructions are not described in detail since they would obscure the invention with unnecessary detail.

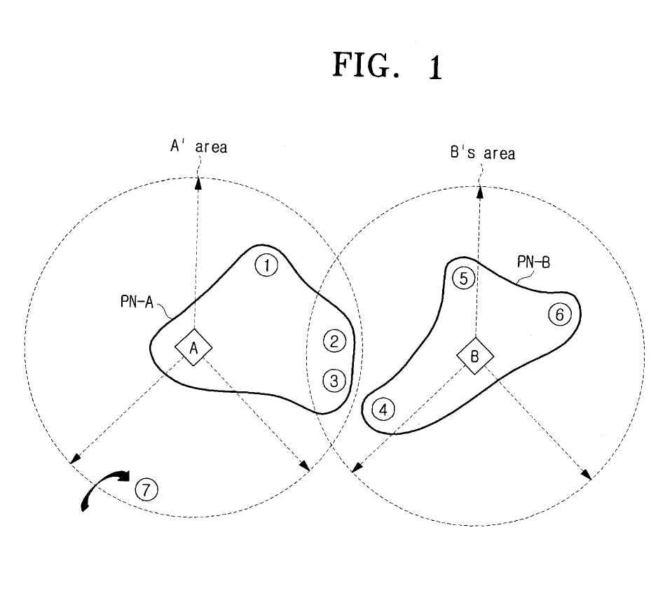

FIG. 1 is a view illustrating a wireless network to which an exemplary embodiment of the present invention is applicable. In FIG. 1, closed curves drawn in a solid line represent piconets. The piconet is a wireless network that is established according to a wireless personal area network (WPAN) scheme.

FIG. 1 shows two piconets, one being a piconet-A (PN-A) centered around a wireless device “A”, the other being a piconet-B (PN-B) centered around a wireless device “B”.

The wireless devices “A” and “B” are piconet coordinators that are adapted to manage piconets. Hereinafter, the wireless devices “A” and “B” are referred to as “PNC “A”” and “PNC “B””, respectively.

The piconet-A (PN-A) is configured by the PNC “A” and wireless devices “1”, “2”, and “3” which are communicably coupled with one another via wireless connection. The wireless devices “1”, “2”, and “3” receive beacons broadcast from the PNC “A”.

The piconet-B (PN-B) is configured by the PNC “B” and wireless devices “4”, “5”, and “6” which are communicably coupled with one another via wireless connection. The wireless devices “4”, “5”, and “6” receive beacons broadcast from the PNC “B”.

The wireless devices “2” and “3” receive beacons broadcast from the PNC “B” in addition to the beacons broadcast from the PNC “A”. This is because the wireless devices “2” and “3” are located in an area where an area (A′area) reachable by the PNC “A” overlaps an area (B′area) reachable by the PNC “B”.

A wireless device “7” also receive beacons broadcast from the PNC “A” because it moves into the area (A′area) reachable by the PNC “A”. Upon receiving the beacons, the wireless device “7” may request approval from the PNC “A” for association with the piconet-A (PN-A).

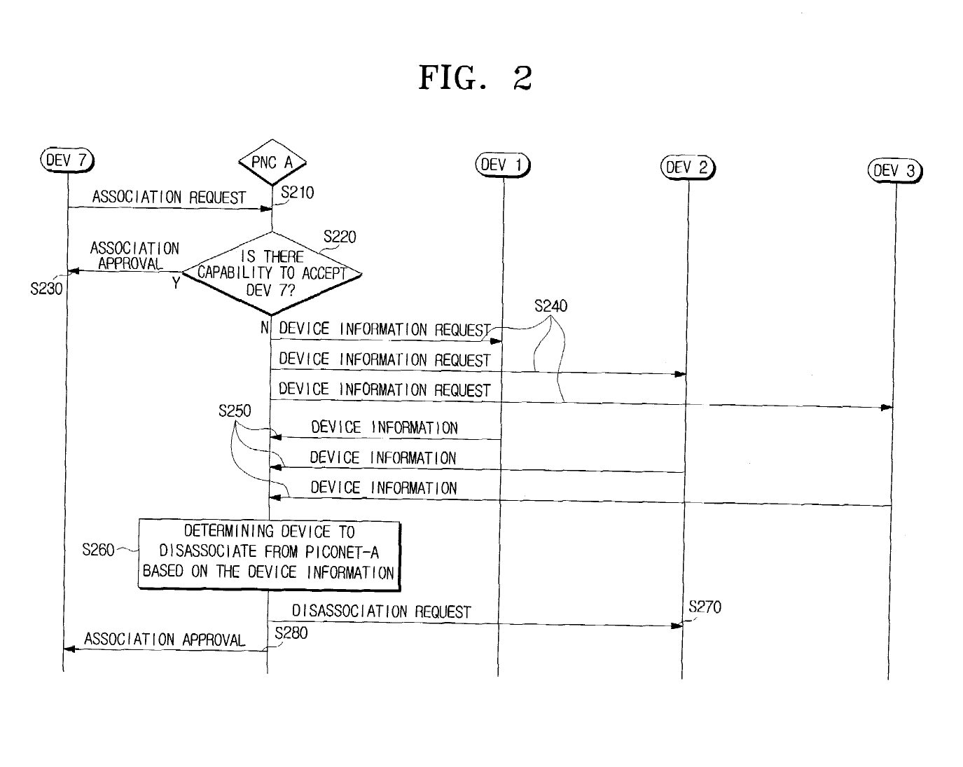

Hereinafter, how the PNC “A” manages the piconet-A (PN-A) when receiving an association request from the wireless device “7” will be described in detail with reference to FIGS. 1 and 2. FIG. 2 is a view illustrating a method for managing the piconet-A (PN-A) of the PNC “A” according to an exemplary embodiment of the present invention.

As shown in FIG. 2, if the PNC “A” receives an ‘association request message’ from the wireless device “7” at operation S210, the PNC “A” determines if the PNC “A” has a capability to accept the wireless device “7” in the piconet-A (PN-A) at operation S220.

More specifically, at operation S220, the PNC “A” determines if ‘the number of wireless devices currently configuring the piconet-A (PN-A)’, which is referred to as “current number” hereinafter, is same as ‘the number of wireless devices the piconet-A (PN-A) can accept’, which is referred to as “acceptable number” hereinafter.

That is, if “current number” is smaller than “acceptable number”, the PNC “A” determines that the PNC “A” has a capability to accept the wireless device “7” in the piconet-A (PN-A). For example, if the acceptable number of the piconet-A (PN-A) is ‘5’ and if the current number is ‘4’ as shown in FIG. 1, the PNC “A” determines that the PNC “A” has a capability to accept the wireless device “7” in the piconet-A (PN-A).

Alternatively, at operation S220, the PNC “A” determines if ‘the number of wireless devices it currently manages is same as ‘the number of wireless devices it can manage’, and then determines if the PNC “A” has a capability to accept the wireless device “7” in the piconet-A.

If it is determined that the PNC “A” has a capability to accept the wireless device “7” (S220-Y), the PNC “A” transmits an ‘association approval message’ to the wireless device “7” at operation S230. Accordingly, the wireless device “7” joins the piconet-A (PN-A) such that the piconet-A (PN-A) is transformed into a piconet where the PNC “A” and the wireless devices “1”, “2”, “3” and “7” are communicably coupled to one another via wireless connection.

After that, the PNC “A” broadcasts information about the piconet-A (PN-A) which has been transformed by the association of the wireless device “7” over the piconet-A (PN-A). Accordingly, the wireless devices “1”, “2”, “3”, and “7” configuring the piconet-A (PN-A) obtain the information about the transformed piconet-A (PN-A).

If the “current number” is same as the “acceptable number”, the PNC “A” determines that the PNC “A” has no capability to accept the wireless device “7”. For example, if the acceptable number of the piconet-A (PN-A) is ‘4’ and if the current number is ‘4’ as shown in FIG. 1, the PNC “A” determines that the PNC “A” has no capability to accept the wireless device “7” in the piconet-A (PN-A).

If it is determined that the PNC “A” has no capability to accept the wireless device “7” (S220-N), the PNC “A” transmits an ‘device information request message’ to the wireless devices “1”, “2”, and “3” configuring the piconet-A (PN-A) at operation S240. The PNC “A” receives information about the devices from the wireless devices “1”, “2”, and “3” as a response to the request at operation S250.

Based on the device information from the wireless devices “1”, “2”, and “3”, the PNC “A” determines which device it will disassociate from the piconet-A (PN-A) at operation S260.

Hereinafter, detailed description will be made about the PNC “A” determines the wireless device to be disassociated from the piconet-A (PN-A) based on the device information at operation S260, on the assumption that the device information includes 1) information on whether or not the wireless device can join another piconet, 2) information on the type of data treated by the wireless device, and 3) information on the amount of data transceived by the wireless device.

The PNC “A” selects a wireless device that can join another piconet as a disassociation candidate. A wireless device that can receive beacons from another piconet is regarded as a wireless device that can join another piconet. In other words, if a wireless device is located in an area where the area reachable by the PNC “A” overlaps an area reachable by a PNC of another piconet, the wireless device is regarded as a wireless device that can join another piconet.

As shown in FIG. 1, since the wireless devices “2” and “3” are located in the area where the area (A's area) reachable by the PNC “A” overlaps the area (B's area) reachable by the PNC “B”, they can join the piconet-B (PN-B).

The device information transmitted from the wireless devices “2” and “3” to the PNC “A” at operation S250 contains information indicating that they can also join the piconet-B (PN-B). Consequently, the PNC “A” selects the wireless devices “2” and “3” as disassociation candidates.

If the number of disassociation candidates is greater than or equal to ‘2’, the PNC “A” selects one of them as a wireless device to disassociate from the piconet-A (PN-A) based on other device information.

More specifically, the PNC “A” uses the information on the type of data treated by the wireless devices to determine a wireless device to be disassociated from the piconet-A (PN-A). For example, if the data treated by the wireless device “3” is regarded as being more important than the data treated by the wireless device “2”, the PNC “A” selects the wireless device “2” to disassociate from the piconet-A (PN-A). This is because the wireless device “3” is given a greater weight on the piconet-A (PN-A) than the wireless device “2”.

If the type of data treated by the wireless device “2” is same as that of the wireless device “3”, which means they are same in how important they are, the PNC “A” uses the information on the amount of data transceived by the wireless devices to determine a wireless device to disassociate from the piconet-A (PN-A). For example, if the amount of data transceived by the wireless device “3” is larger than that of the wireless device “2”, the PNC “A” selects the wireless device “2” to disassociate from the piconet-A (PN-A). This is because that the wireless device “3” is given a greater weight on the piconet-A (PN-A) than the wireless device “2”.

As described above, if the wireless device “2” is to be disassociated from the piconet-A (PN-A) at operation S260, the PNC “A” transmits a ‘disassociation request message’ to the wireless device “2” at operation S270. Then, the PNC “A” transmits an ‘association approval message’ to the wireless device “7” at operation S280.

The PNC “A” may perform the operation S280 after receiving from the wireless device “2” a ‘disassociation approval message’ that is a response to the ‘disassociation request message’ transmitted at operation S270.

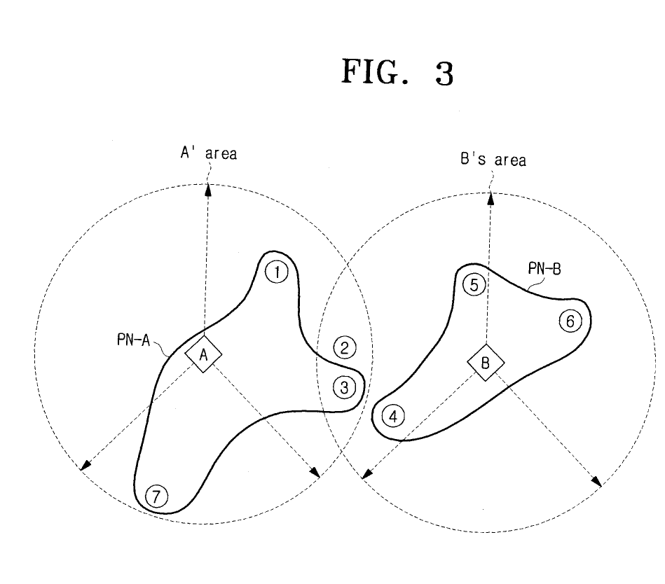

As a result of performing the operations S270 and S280, the wireless device “2” is disassociated from the piconet-A (PN-A) and the wireless device “7” is newly associated with the piconet-A (PN-A), and thus, the piconet-A (PN-A) is transformed into a piconet that is configured by the PNC “A” and wireless devices “1”, “3”, and “7”, in which they are communicably coupled to one another via wireless connection. FIG. 3 shows the transformed piconet-A (PN-A).

After that, the PNC “A” broadcasts information on the piconet-A (PN-A) transformed by the disassociation of the wireless device “2” and the association of the wireless device “7” over the piconet-A (PN-A). Accordingly, the wireless devices “1”, “3”, and “7” obtain the information on the transformed piconet-A (PN-A).

Up to now, the descriptions were made about the process of the PNC disassociating one of the wireless devices configuring the piconet at the time of a request for approval for association from a wireless device which wishes to join the piconet according to an exemplary embodiment of the present invention.

This embodiment is based on the assumption that there is only one wireless device which wishes to join the piconet. However, this is merely an example for the convenience of explanation and the technical idea of the present invention will be applicable to the case where there are many numbers of wireless devices which wish to join the piconet. In that case, if the sum of ‘the number of wireless devices currently configuring the piconet’ and ‘the number of wireless devices which wish to join the piconet’ exceeds ‘the number of wireless devices that the piconet can accept’, the disassociation of a wireless device is performed.

In this embodiment, a wireless device is determined to be disassociated from the piconet if a wireless device which wishes to join the piconet moves and appears in the reachable range of the PNC of the piconet. However, this is merely an example for the convenience of explanation, and the technical idea will also be applied in different situations.

For example, if a channel used by the piconet is in a bad condition (for example, if a specific wireless device of the piconet is allocated a broad bandwidth), if a load of the PNC adapted to manage the piconet increases, and if a wireless device located in the area reachable by the PNC of the piconet is switched from a power-off state to a power-on state, the technical idea of the present invention will also be applied.

Also, in this embodiment, a wireless device is to be disassociated from the piconet if a wireless device which wishes join the piconet appears. However, in another exemplary embodiment, the PNC may not disassociate a wireless device from the piconet and may refuse to accept a new wireless device which wishes join the piconet. In that case, based on information about the existing wireless device associated with the piconet and information about a new wireless device which wishes to join the piconet, the PNC determines whether to disassociate the existing wireless device or to refuse to accept the new wireless device which wishes to join the piconet.

Also, in this embodiment, the information about the wireless device includes 1) information on whether or not the wireless device can join another piconet, 2) information on the type of data treated by the wireless device, and 3) information on the amount of data transceived by the wireless device. However, this is merely an example for the convenience of explanation. The information about the wireless device may include some of these three types of information, and also may include different types of information.

Examples of the different types of information are information about a transmission power of the wireless device and information about the priority order of the wireless device. The transmission power is a criterion used in measuring a distance within which the wireless device can transmit data. The priority order of the wireless device is another criterion used in determining a wireless device to be disassociated from the piconet. For example, if two wireless devices configuring the piconet should be disassociated from the piconet, the two wireless devices having a low priority order are disassociated from the piconet.

Also, in this embodiment, the information described above is used in the order of 1), 2), and 3) in determining a wireless device to be disassociated from the piconet. However, this is merely an example for the convenience of explanation. An application adopting a different order belongs to the scope of the present invention.

Also, in this embodiment, it is the PNC that determines a wireless device to be disassociated from the piconet, but it may be possible for another wireless device adapted manage the piconet to perform this determination.

Also, a wireless device may be determined to be disassociated from the piconet manually by a user of the PNC, rather than automatically by the PNC.

Also, in this embodiment, a network to which the present invention is applied is a piconet which is a kind of WPAN. However, this is merely an example for the convenience of explanation. The present invention will be applied to a different type of WPAN, and also may be applied to a local personal area network (WLAN).

Please note that any device that has a function of wireless communication can be used as a wireless device, and the wireless device mentioned above includes a PNC. A video device such as a TV, a set-top box, and a personal multimedia player (PMP), a communication device such as a PC and a mobile phone, and other devices known in the art may be used as the wireless devices herein.

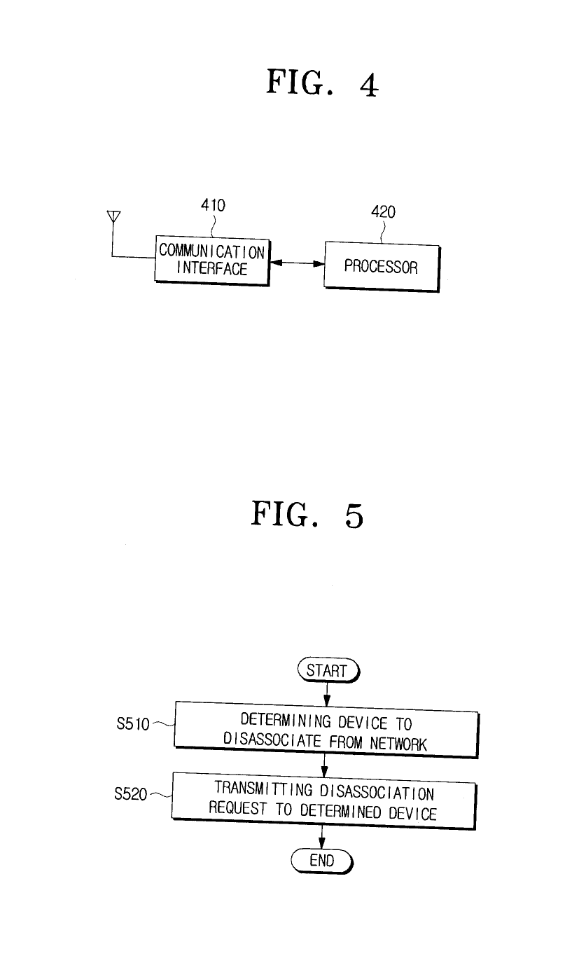

Hereinafter, another exemplary embodiment of the present invention will be described in detail with reference to FIGS. 4 and 5.

According to another exemplary embodiment of the present invention, a wireless device comprises a communication interface 410 and a processor 420 as shown in FIG. 4.

The communication interface 410 is communicably coupled with another wireless device configuring a wireless network. The processor 420 determines a wireless device to be disassociated from the wireless network, and transmits a ‘disassociation request message’ to a wireless device which is to be disassociated from the wireless network through the communication interface 410.

According to a method for managing a network as shown in FIG. 5, the wireless device determines a wireless device to be disassociated from the wireless network among the wireless devices configuring the network at operation S510. Then, the wireless device transmits a ‘disassociation request message’ to the wireless device which is to be disassociated from the wireless network at operation S520.

Network management is possible by the above-described method.

As described above, it is possible to determine a wireless device to be disassociated from the wireless network and to disassociate the determined wireless device from the wireless network.

Accordingly, since an existing wireless device can be forcedly disassociated from the wireless network, the number of wireless devices configuring the wireless network can be artificially adjusted.

Also, since an existing wireless device is forcedly disassociated from the wireless network and a new wireless device is associated with the wireless network, the configuration of the wireless networks can be changed more reasonably.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for managing a wireless network, comprising:
among wireless devices configuring the wireless network, determining a wireless device to be disassociated from the wireless network; and
transmitting a disassociation request message to the wireless device which is to be disassociated from the wireless network.

2. The method as claimed in claim 1, further comprising receiving information about the wireless devices configuring the wireless network, and wherein the determining step comprises determining a wireless device to be disassociated from the wireless network based on the information about the wireless devices received at the receiving step.

3. The method as claimed in claim 2, wherein the information about the wireless devices comprises information indicating whether or not each of the wireless devices can join another wireless network different from the wireless network, and the determining step comprises determining at least one of the wireless devices that can join another wireless network as a wireless device to be disassociated from the wireless network.

4. The method as claimed in claim 2, wherein the information about the wireless devices comprises information about a type of data treated by each of the wireless devices, information about an amount of data transceived by each of the wireless devices, information about a transmission power of each of the wireless devices, and information about a priority order of each of the wireless devices.

5. The method as claimed in claim 1, wherein the determining step is performed if the sum of the number of wireless devices currently configuring the wireless network and the number of wireless devices which wish to join the wireless network exceeds the number of wireless devices that the wireless network can accept.

6. The method as claimed in claim 5, wherein if a wireless device which wishes to join the wireless network appears, the sum exceeds the number of wireless devices that the wireless network can accept.

7. The method as claimed in claim 1, wherein the determining step is performed in either case where a channel used by the wireless network is in a bad condition or where a load of a wireless device adapted to manage the wireless network increases.

8. The method as claimed in claim 1, wherein the determining and the transmitting steps are performed by a wireless device adapted to manage the wireless network.

9. The method as claimed in claim 1, wherein the wireless network is either a wireless personal area network (WPAN) or a wireless local area network (WLAN).

10. The method as claimed in claim 1, further comprising:
transmitting an association approval message to a wireless device which requests approval for association with the wireless network; and
transmitting information about the wireless network which has been transformed as a result of disassociating the wireless device which is to be disassociated from the wireless network and associating the wireless device which requests approval for association with the wireless network, to the wireless devices configuring the wireless network.

11. A wireless device comprising:
a communication interface which is communicably coupled to wireless devices configuring a wireless network; and
a processor which determines a wireless device to be disassociated from the wireless network, and transmits a disassociation request message to the wireless device which is to be disassociated from the wireless network through the communication interface.

12. The wireless device as claimed in claim 11, wherein the processor receives information about the wireless devices configuring the wireless network through the communication interface, and determines a wireless device to disassociate from the wireless network based on the information about the wireless devices.
